(19) United States
(12) Patent Application Publication
(10) Pub. No.: US 2019/0337362 A1
(43) Pub. Date: Nov. 7, 2019

(54) DEVICE FOR ARTICULABLY MOUNTING A SUN SHIELD WITHIN A MOTOR VEHICLE

(71) Applicant: T.M. SHEA PRODUCTS, INC., Troy, MI (US)

(72) Inventor: Thomas M. SHEA, Troy, MI (US)

(73) Assignee: T.M. SHEA PRODUCTS, INC., Troy, MI (US)

(21) Appl. No.: 16/402,304

(22) Filed: May 3, 2019

Related U.S. Application Data
(60) Provisional application No. 62/666,222, filed on May 3, 2018.

(51) Int. Cl. B60J 3/02

(52) U.S. Cl. CPC B60J 3/0208; B60J 3/026

(57) ABSTRACT

A device for articulably mounting a sun shield within a motor vehicle includes a mounting member, a sun shield holder and a connecting member. The mounting member releasably secures the device to a visor of the sun motor vehicle. The sun shield holder attaches the device to the sun shield. The connecting member connects the mounting member and the sun shield holder. In one embodiment the connecting member defining at least one ball and socket joint. In another embodiment, the connecting member defines a single pivot axis about which the sun shield may rotate relative to the mounting member in a plane of the planar sun shield.

### CROSS-REFERENCE TO RELATED APPLICATION

This application claims the benefit of U.S. Provisional Patent Application No. 62/666,222 filed 3 May 2018, which application is herein expressly incorporated by reference.

### FIELD

The present teachings generally relate to sun shield for a motor vehicle. The present teachings more particularly related to a device for articulably mounting a sun shield within a motor vehicle.

### DISCUSSION

Glare from the sun negatively affects a driver's ability to adequately see when operating a vehicle. Such sun glare is generally most concerning at day break and during sunset. During the periods, a conventional sun visor may not adequately block sun glare.

A number of solutions have been heretofore proposed for further reducing or eliminating glare from the sun. Many of these solutions are attachable to the conventional visor. While some known solutions may have proven to be generally satisfactory for the limited purposes, many have been failures and all are associated with limitations. Accordingly, there remains a need for continuous improvement within the relevant art.

### SUMMARY

In accordance with one particular aspect, the present teachings provide a device for articulably mounting a sun shield within a motor vehicle. The device includes a mounting member, a sun shield holder and a connecting member. The mounting member releasably secures the device to a visor of the sun motor vehicle. The sun shield holder attaches the device to the sun shield. The connecting member connects the mounting member and the sun shield holder. The connecting member defining at least one ball and socket joint.

In accordance with another particular aspect, the present teachings provide a sun shielding arrangement including a sun shield and at least one device for articulably mounting the sun shield. The at least one device for articulably mounting the sun shield includes a first portion for releasably engaging the sun shield and a second portion for mounting to one of a vehicle visor, vehicle window, office window and home window.

In accordance with yet another particular aspect, the present teachings provide a device for articulably mounting a sun shield within a motor vehicle. The device includes a mounting member, a planar sun shield and a coupling connection. The mounting member releasably secures the device to a visor of the motor vehicle and includes first and second jaws. The coupling connection is between the planar sun shield and one of the first and second jaws. The coupling connection allowing rotation of the planar sun shield relative to the mounting member in a plane of the planar sun shield.

In accordance with still another aspect, the present teachings provide a method of shielding a passenger of a motor vehicle from sun glare. The method includes providing a planar sun shield and articulably mounting the sun shield to a structure within the vehicle with a device including a mounting member and a connecting member. The connecting member includes at least one ball and socket joint. The method further includes adjusting a position and/or orientation of the planar sun shield within the vehicle by articulating the at least one ball and socket joint.

### BRIEF DESCRIPTION OF THE DRAWINGS

The present invention will become more fully understood from the detailed description and the accompanying drawings, wherein:

FIG. 1 is a perspective view of a device for articulably mounting a sun shield within a motor vehicle in accordance with the present teachings, the device shown mounted to a motor vehicle visor and operatively associated with the sun shield.

FIG. 2 is another perspective view of the device for articulably mounting a sun shield within a motor vehicle of FIG. 1 shown mounted to a motor vehicle visor and operatively associated with the sun shield.

FIG. 3 is another perspective view of the device for articulably mounting a sun shield within a motor vehicle of FIG. 1 shown mounted to a motor vehicle visor and operatively associated with the sun shield.

FIG. 4 is another perspective view of the device for articulably mounting a sun shield within a motor vehicle of FIG. 1 shown mounted to a motor vehicle visor and operatively associated with the sun shield.

FIG. 5 is another perspective view of the device for articulably mounting a sun shield within a motor vehicle of FIG. 1 shown mounted to a motor vehicle visor and operatively associated with the sun shield.

FIG. 6 is another perspective view of the device for articulably mounting a sun shield within a motor vehicle of FIG. 1 shown mounted to a motor vehicle visor and operatively associated with the sun shield.

FIG. 7 is another perspective view of the device for articulably mounting a sun shield within a motor vehicle of FIG. 1 shown mounted to a motor vehicle visor and operatively associated with the sun shield.

FIG. 8 is another perspective view of the device for articulably mounting a sun shield within a motor vehicle of FIG. 1 shown mounted to a motor vehicle visor and operatively associated with the sun shield.

FIG. 9 is a partially exploded perspective view of the device for articulably mounting a sun shield within a motor vehicle of FIG. 1 showing attachment of the device to the sun shield.

FIG. 10 is another perspective view of the device for articulably mounting a sun shield within a motor vehicle of FIG. 1, the device shown operatively associated with the sun shield.

FIG. 11 is a left side view of the device for articulably mounting a sun shield within a motor vehicle of FIG. 1, the device shown operatively associated with the sun shield.

FIG. 12 is a right side view of the device for articulably mounting a sun shield within a motor vehicle of FIG. 1, it being understood that the left side view is a mirror image of the right side view, the device shown operatively associated with the sun shield.

FIG. 13 is a front view of the device for articulably mounting a sun shield within a motor vehicle of FIG. 1, the device shown operatively associated with the sun shield.

FIG. 14 is a rear view of the device for articulably mounting a sun shield within a motor vehicle of FIG. 1, the device shown operatively associated with the sun shield.

FIG. 15 is a top view of the device for articulably mounting a sun shield within a motor vehicle of FIG. 1, the device shown operatively associated with the sun shield.

FIG. 16 is a bottom view of the device for articulably mounting a sun shield within a motor vehicle of FIG. 1, the device shown operatively associated with the sun shield.

FIG. 17 a perspective view of another device for articulably mounting a sun shield within a motor vehicle in accordance with the present teachings, the device shown operatively associated with the sun shield.

FIG. 18 another perspective view of the device for articulably mounting a sun shield within a motor vehicle of FIG. 17, the device shown operatively associated with an alternative sun shield.

FIG. 19 is a perspective view of the device for articulably mounting a sun shield within a motor vehicle of FIGS. 17 and 18.

FIG. 20 is a perspective view of another device for articulably mounting a sun shield within a motor vehicle in accordance with the present teachings, the device shown operatively associated with the sun shield.

FIG. 21 is a perspective view of the device for articulably mounting a sun shield within a motor vehicle of FIG. 20.

FIG. 22 illustrates arrangement incorporating a plurality of devices for articulably mounting a sun shield within a motor vehicle.

FIG. 23 illustrates another arrangement incorporating a plurality of devices for articulably mounting a sun shield within a motor vehicle.

FIG. 24 illustrates another arrangement incorporating a plurality of devices for articulably mounting a sun shield within a motor vehicle.

FIG. 25 illustrates another arrangement incorporating a plurality of devices for articulably mounting a sun shield within a motor vehicle, home or office.

FIG. 26 is a perspective view of a sun shielding device in accordance with the present teachings.

FIG. 27 is a perspective view of the sun shielding device of FIG. 26 shown operatively attached to a visor of a motor vehicle.

It will be understood that the various embodiments shown throughout the application are drawn to scale. Like reference characters have been used throughout the various views to identify like elements.

### DESCRIPTION OF VARIOUS ASPECTS

The following description is merely exemplary in nature and is in no way intended to limit the invention, its application, or uses.

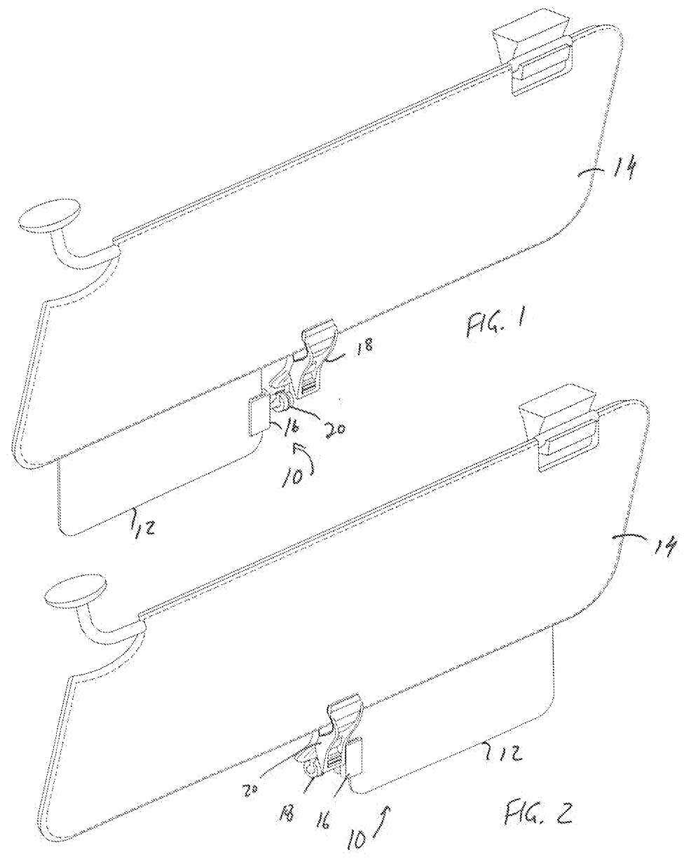

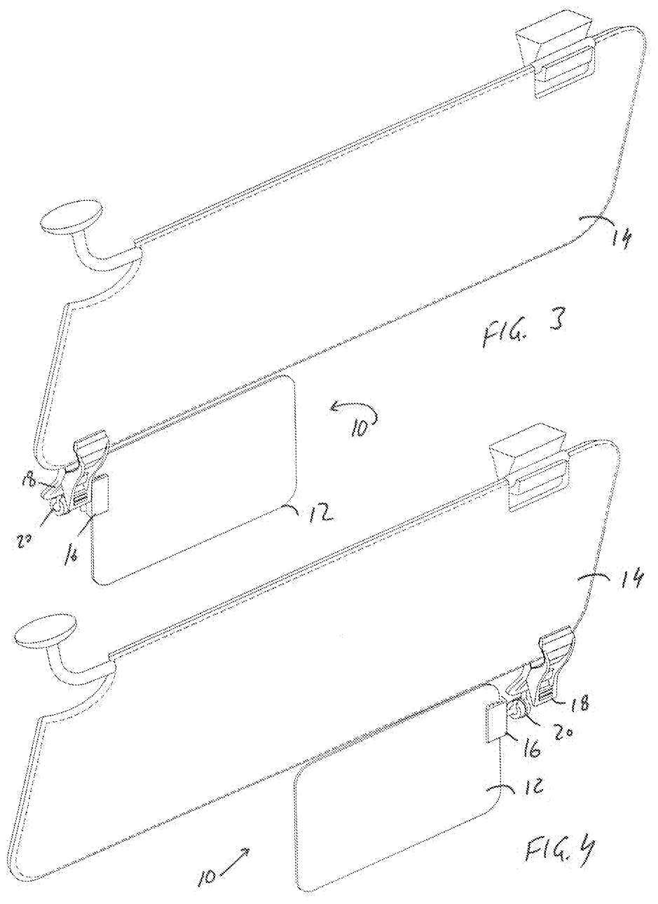

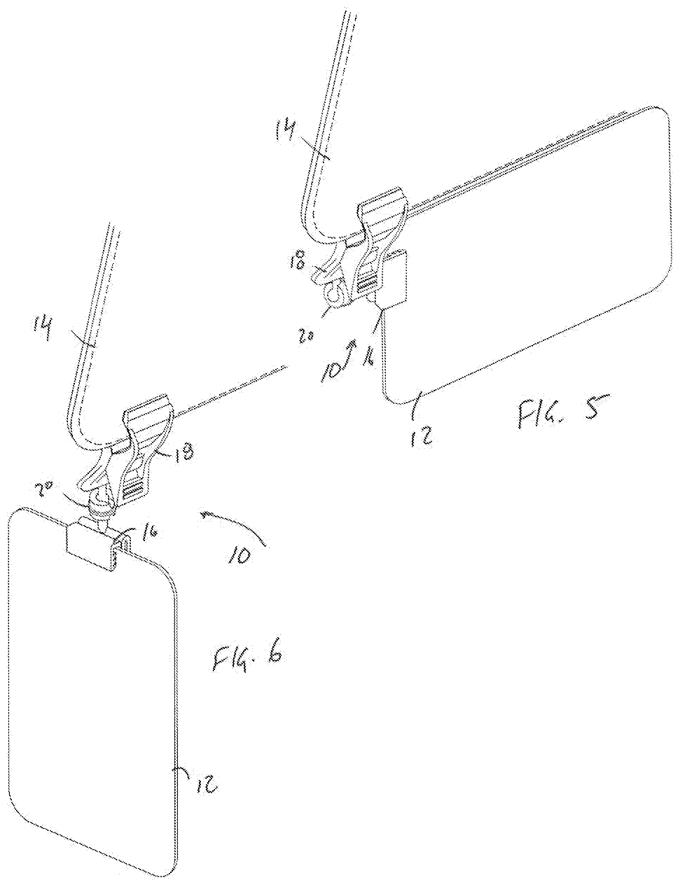

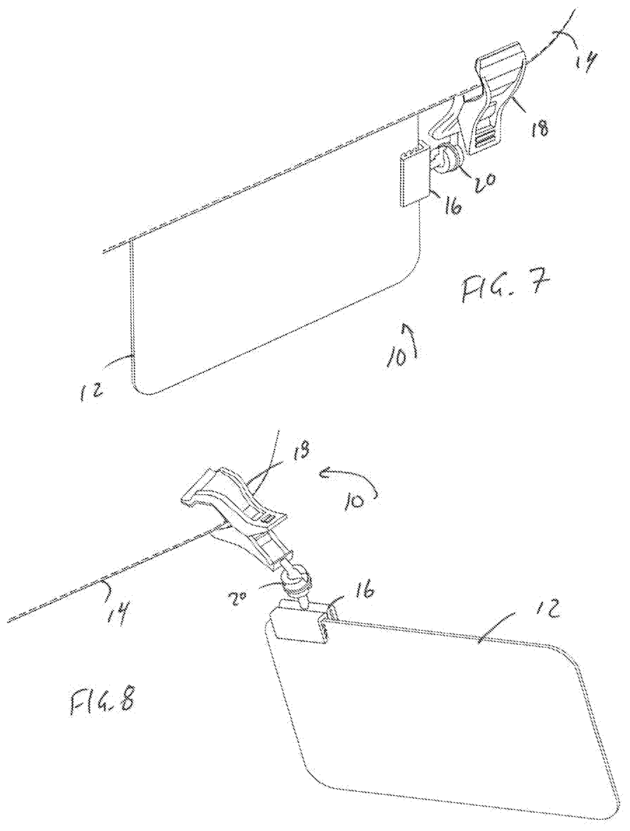

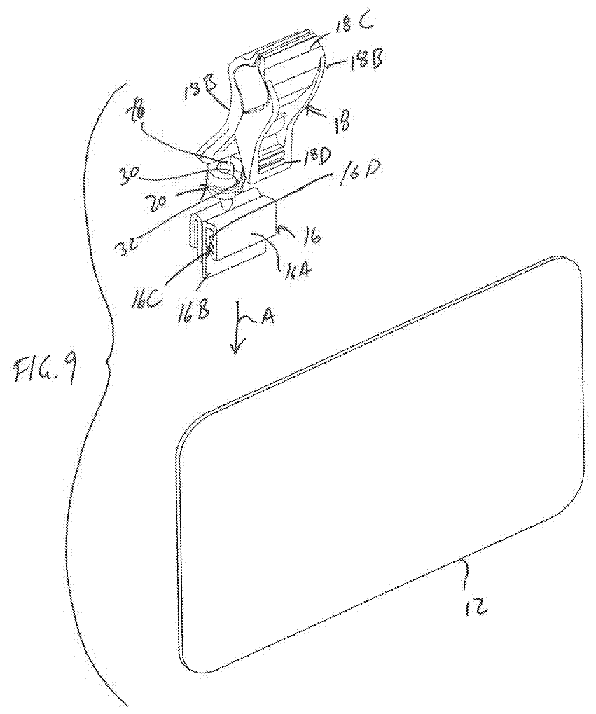

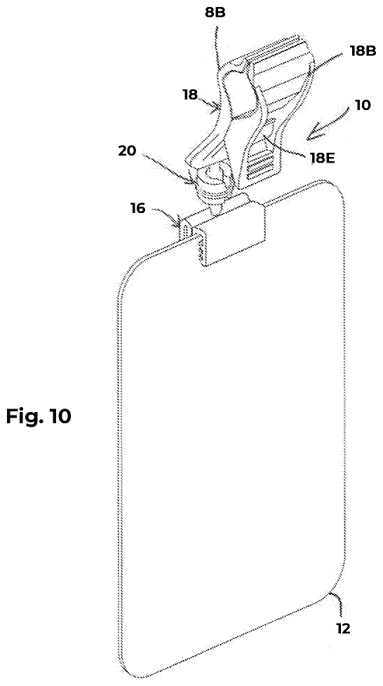

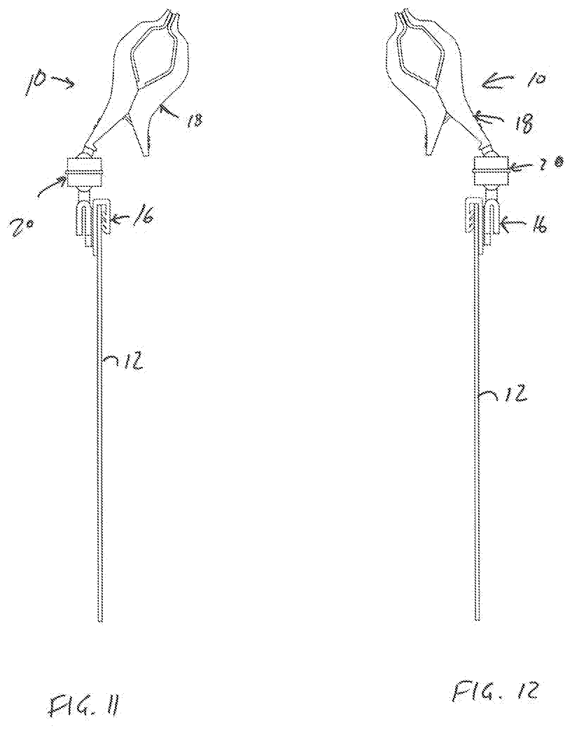

With initial reference to FIGS. 1 through 16, a device for articulably mounting a sun shield within a motor vehicle in accordance with the present teachings is illustrated and generally identified at reference character 10. In FIGS. 1 through 8, a series of perspective views illustrating the flexibility of the device 10 is provided. In these views, the device 10 is shown operably associated with a sun shield 12 and attached to a conventional sun visor 14. An exploded view is provided in FIG. 9 show attachment of the device 10 to the sun shield 12 in the direction of arrow A. FIGS. 10 through 16 further illustrate various details of the device 10, the device 10 again shown operatively associated with the sun shield 12.

The device 10 for articulably mounting a sun shield within a motor vehicle is shown throughout the drawings to generally include a first portion or sun shield mounting portion 16, a second portion or mounting member 18 and a third portion or coupling member 20.

The sun shield 12 may be a planar member constructed of thin cardboard, card stock, plastic or other suitable material. In so far as the sun shield 12 is constructed of cardboard, card stock, plastic or other suitable material, it can function to completely block sunlight. In other applications, the sun shield 12 may be constructed of a material that only restricts the passage of sun light (e.g., the sun shield material may be a solid color or translucent).

The sun shield 12 may be rectangular or any other suitable shape. The sun shield 12 has a length L and a height H. In one particular application, the length L is approximately 6 inches and the height H is approximately 4 inches. It will be understood that these dimensions are exemplary and may vary within the scope of the present teachings.

The sun shield 12 may be formed of card stock or plastic. Alternatively, the sun shield 12 may be formed of cardboard or any other material known in the art. The sun shield may be blank or may be pre-printed or otherwise adorned with graphics. The graphics may advertise the manufacturer of the device 10. Alternatively, the graphics may be used to advertise a third party company, product or group. It is envisioned that the device 10 may be used as a promotional device.

The first portion 16 may be adapted to releasably and securely engage the sun shield 12. The first portion 16 unitarily constructed and may be generally U-shaped including first and second downwardly extending legs 16A and 16B (see FIG. 9, for example). The legs 16A and 16B may be spaced apart by a gap 16C for receiving the sun shield 12. The first portion 16 may further include a plurality of retaining members 16D inwardly extending from one or both of the legs 16A and 16B. The retaining members 16D may be integrally formed with the first portion 16 and may deflect upon introduction of the sun shield 12 into the gap 16C and hold the sun shield 12 within the gap 16D in response to a force in the direction of arrow A (see FIG. 9). In this manner, the device 10 may be quickly and securely attached to the sun shield 12.

The second portion 18 is quickly and releasably attachable to the visor 14. As illustrated, the second portion 18 may generally include a pair of jaws 18B. Each jaw 18B includes a gripping end 18C and a grasping end 18D. The jaws 18B may be joined by a clamping element 18E (see FIG. 10, for example). The clamping element 18E may be C-shaped and may be manually and elastically deformable a closed position illustrated throughout the drawings to an open position.

The third portion 20 or coupling member connects the first portion 16 and the second portion 18 in such a manner that the first portion 16 may be articulated relative to the second portion 18. In the embodiment illustrated, the third portion 20 defines at least one ball and socket joint. More particularly, in the embodiment illustrated, the third portion 20 defines first and second ball and socket joints. It will be understood that the ball and socket joints have sufficient inherent friction to maintain a desired orientation between the ball and the socket until such orientation is manually changed. In this regard, the sun shield 12 may be quickly and easily moved to various desired positions without moving the mounting of the device 10.

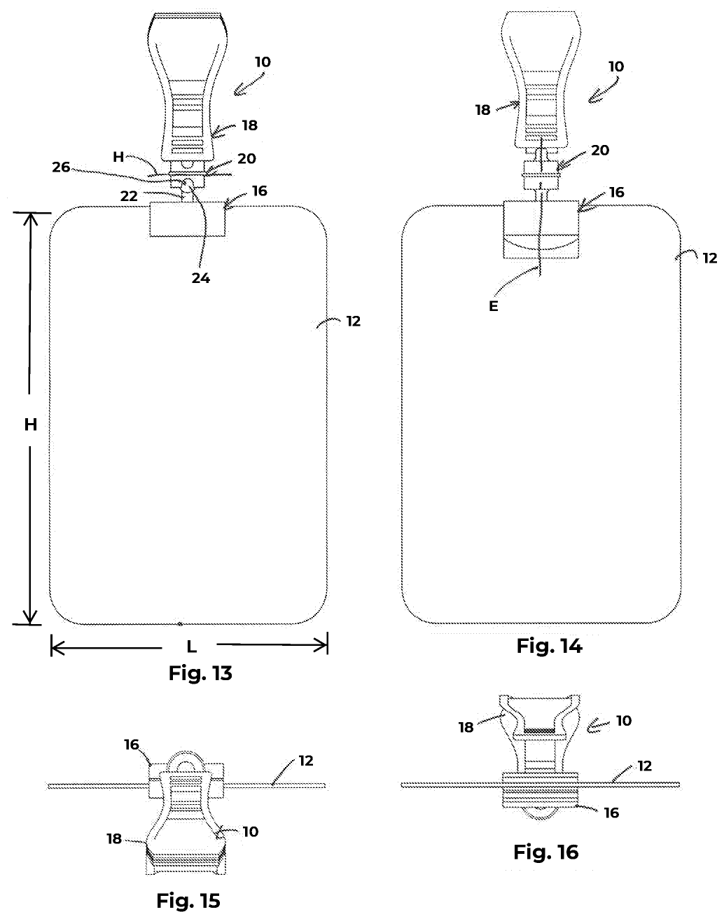

The third portion 20 may be unitarily constructed of plastic or any other suitable material. In the embodiment illustrated, the third portion 20 is a mirror image about a horizontal midline H (see FIG. 13). The first ball and socket is defined between the third portion 20 and the first portion 16. In this regard, the third portion 20 defines the socket. An arm 22 extends from the first portion 16 and terminates at a ball 24 of the first ball and socket. The lower part of the third portion 20 includes a cutout 26 that accommodates the arm 22 and permits the arm 22 to articulate perpendicular to an elongated axis E of the third portion 20.

The second ball and socket is defined between the third portion 20 and the second portion 18. In this regard, the third portion 20 again defines the socket. An arm 28 (see FIG. 9, for example) extends from the second portion 18 and terminates at a ball 30 of the second ball and socket. The upper part of the third portion 20 includes a cutout 32 that accommodates the arm 28 and permits the arm 28 to articulate perpendicular to the elongated axis E of the third portion 20.

Explaining further, the first ball and socket joint provides universal movement between the first portion 16 and the third portion 20 of the device 10. In this regard, the arm 28 and thereby the first portion may rotate 360 degrees about an elongated axis of the arm 28. Further, the arm 28 and thereby the first portion 16 may pivot about a center point of the ball 30. This pivoting is available in any direction perpendicular to the elongated axis of the arm 28. The second ball and socket joint similarly provides universal movement between the second portion 18 and the third portion 20 of the device 10.

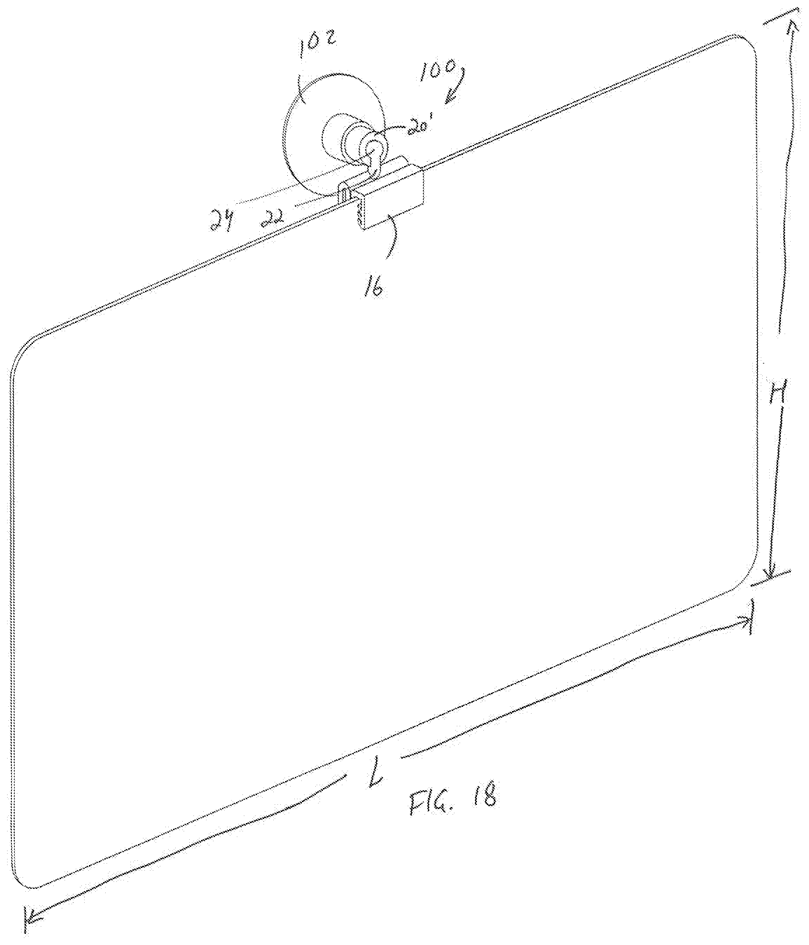

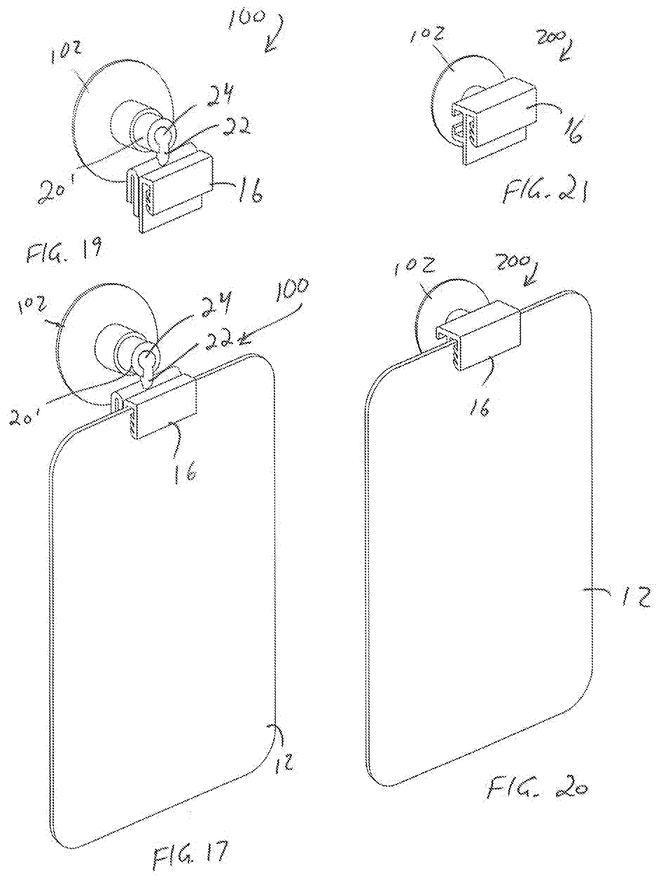

Turning to FIGS. 17 through 19 of the drawings, another device for articulably mounting a sun shield within a motor vehicle in accordance with the present teachings is illustrated and generally identified at reference character 100. Given the similarities between the device 100 and the device 10, common reference characters will be used to identify similar elements. The device 100 primarily differs from the device 10 in that it includes a second portion 102 in the form of a suction cup 102. The suction cup 102 may be used to securely and quickly attach the device 100 to a glass surface or similar surface. The third portion 20′ defines a single ball and socket joint.

In the particular application shown in FIG. 18, sun shield may have a length L that is approximately 11.75 inches and a height H that is approximately 8.5 inches. It will be understood that these dimensions are exemplary and may be modified within the scope of the present teachings. inches.

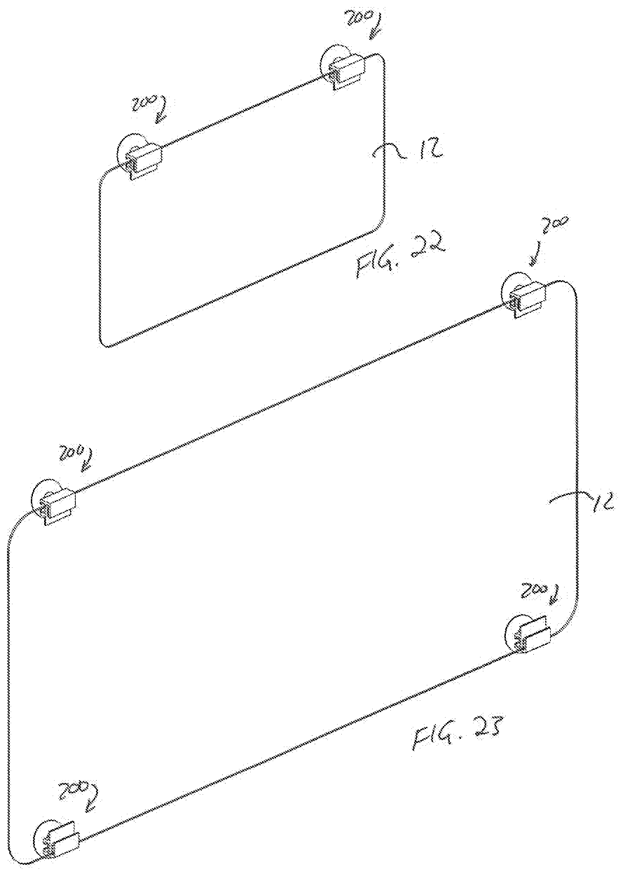

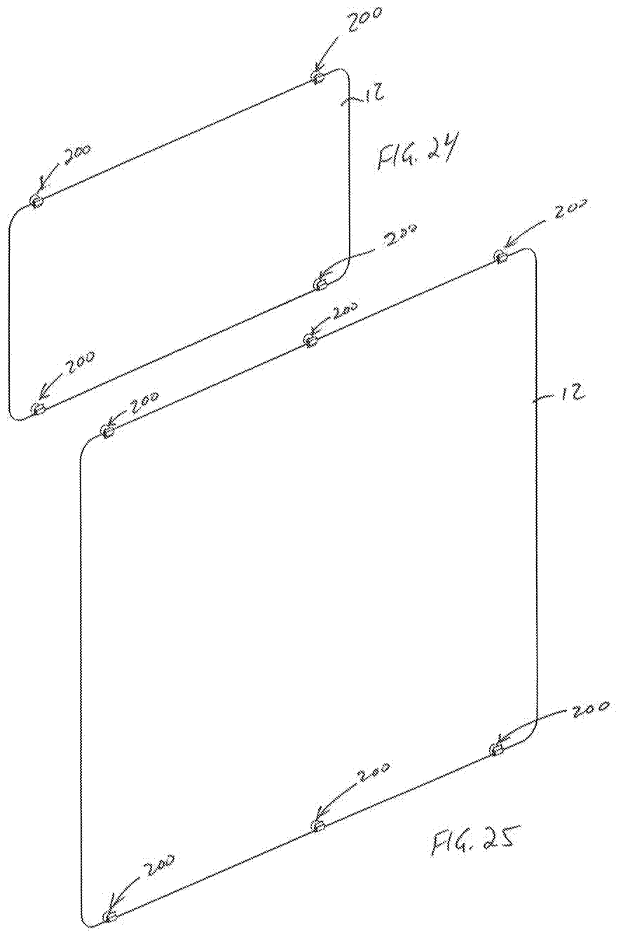

Turning to FIGS. 20 through 23, another device for articulably mounting a sun shield within a motor vehicle in accordance with the present teachings is illustrated and generally identified at reference character 100. The device 200 of FIGS. 24 and 25 may be used for office and home windows, for example. Given the similarities between the device 200 and the device 100, common reference characters will be used to identify similar elements. The device 200 primarily differs from the device 100 in that the device 200 includes a first portion 16 coupled directly to the suction cup 102. The first portion 16 may rotate relative to the suction cup 102 about an axis extending through a center of the suction cup 102. In other applications, the first portion 16 may be fixedly attached to the suction cup 102.

As shown throughout FIGS. 20-25, a single device 200 may be used with a sun shield 12 or a plurality of devices 200 may be used with a sun shield 12. The number of devices 200 may depend on the size of the sun shield 12 or on the particular application of use. For example, a greater number of devices 200 may be employed where it is anticipated that the sun shield 12 may be exposed to strong wind conditions (e.g., for a rear side window application when the front window is down).

Larger sun shields 12 may be used for vehicle side windows. Such sun shields 12 may measure 8.5 inches by 11.75 inches or 11.75 inches by 17.75 inches, for example. Still yet larger sun shields 12 may be used for vehicle rear window applications or office/home window applications. Such sun shield 12 may measure 24 inches by 36 inches or 36 inches by 48 inches, for example. When used in a vehicle, the combined device 200 and sun shield 12 may be used to complete block the rays of the sun for the comfort of the passengers, reduce the rays of the sun for the comfort of the passengers or block the rays of the sun to reduce the interior temperature of the vehicle when the vehicle is parked. Regardless of the particular use, it will again be understood that any dimensions set forth herein are exemplary and may be modified for particular applications within the scope of the present teachings.

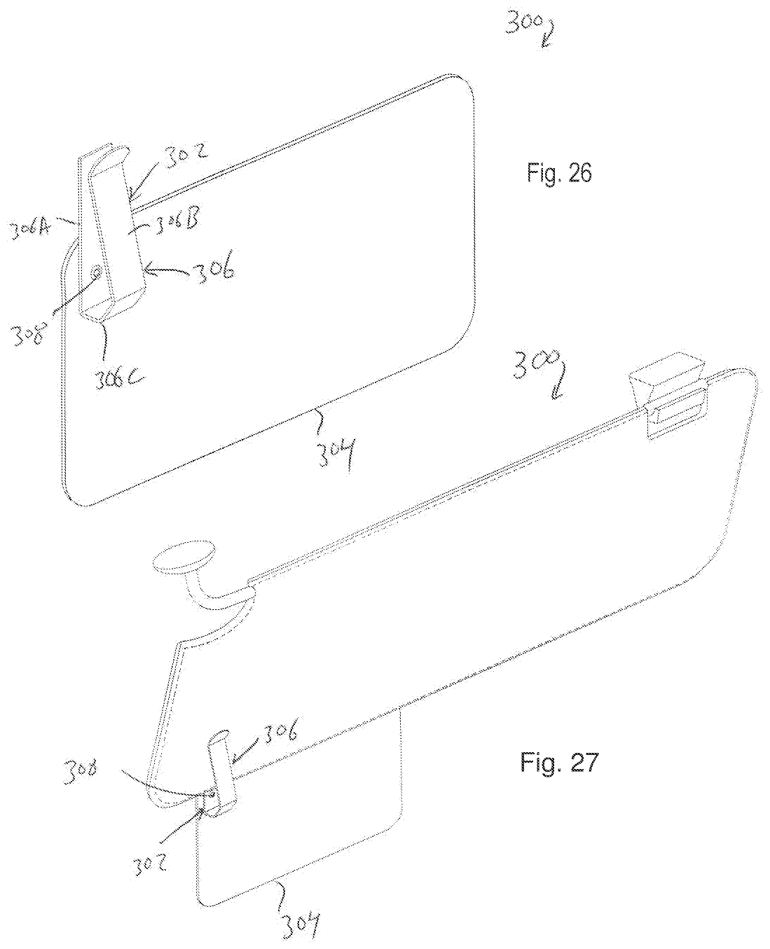

Turning to FIGS. 26 and 27, a sun shielding arrangement in accordance with the present teachings is illustrated and identified at reference number 300. The sun shielding arrangement 300 is illustrated to generally include a device 302 for articulably mounting a sun shield 304 within a motor vehicle. The device 302 includes a mounting member 306 and a coupling member or coupling connection 308. The mounting member 306 functions to releasably secures the device 302 to a visor 304 of the motor vehicle and may include first and second jaws 306A and 306B. In the embodiment illustrated, the mounting member 306 may be formed of a single piece of bent metal. The first and second jaws 306A and 306B may be connected to one another by an intermediate portion 306C. The intermediate portion 306C may allow the jaws to be normally be separated a first distance when subject to no outer forces and separated a second, larger distance when the mounting member 306 is inelastically deformed. In this manner, the mounting member 306 may be retained to the visor 304 under an inherent bias.

The coupling connection 308 is between the planar sun shield 304 and one of the first and second jaws 306A and 306B. In the embodiment illustrated, the coupling connection 308 is a rivet that passes through the first jaw 306A and engages the planar sun shield 304. The coupling connection 308 allows for rotation of the planar sun shield 304 relative to the mounting member 302 in a plane of the planar sun shield 304. In this manner the planar sun shield 304 may pivot about a single point anywhere along an edge of the visor. The rivet has a slight friction on it to keep maintain a stable position of the planar sun shield 304 in any orientation relative to the visor. The mounting member 306 may easily slide along the edge of the visor by the user to track the sun during driving.

It will now be appreciated that the present teachings provide a device for articulably mounting a sun shield within a motor vehicle with improved flexibility that can be securely mounted within a motor vehicle to further address issues resulting from sun glare. As a result, driving can be made easier and safer by reducing or eliminating sun hot spots.

While specific examples and alternatives have been described in the specification and illustrated in the drawings, it will be understood by those skilled in the art that various further changes may be made by and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. A device for articulably mounting a sun shield within a motor vehicle, the device comprising:
a mounting member for releasably securing the device to a visor of the sun motor vehicle;
a sun shield holder for attaching the device to the sun shield; and
a connecting member for connecting the mounting member and the sun shield holder, the connecting member defining at least one ball and socket joint.

2. The device for articulably mounting a sun shield within a motor vehicle of claim 1, wherein at least one ball and socket joint includes first and second ball and socket joints.

3. The device for articulably mounting a sun shield within a motor vehicle of claim 1, wherein the mounting member includes a pair of jaws.

4. The device for articulably mounting a sun shield within a motor vehicle of claim 1, wherein the mounting member includes a suction cup.

5. A sun shielding arrangement comprising:
a sun shield; and
at least one device for articulably mounting the sun shield, the at least one device including a first portion for engaging the sun shield and a second portion for mounting to one of a vehicle visor, vehicle window, office window and home window.

6. The sun shielding arrangement of claim 5, wherein the at least one device for articulably mounting the sun shield further includes a third portion connecting the mounting member and the sun shield holder, the third portion defining at least one ball and socket joint.

7. The sun shielding arrangement of claim 5, wherein the second portion includes a suction cup.

8. The sun shielding arrangement of claim 5, wherein the second portion includes first and second jaws.

9. The sun shielding arrangement of claim 5, wherein the first portion releasably engages the sun shield.

10. The sun shielding arrangement of claim 5, wherein the first portion permanently engages the sun shield.

11. The device for articulably mounting a sun shield within a motor vehicle of claim 1, wherein:
further comprising a planar sun shield and the mounting member for releasably securing the device to a visor of the motor vehicle includes first and second jaws; and
the connecting member includes a coupling connection between the planar sun shield and one of the first and second jaws, the coupling connection allowing rotation of the planar sun shield relative to the mounting member in a plane of the planar sun shield.

12. The device for articulably mounting a sun shield within a motor vehicle of claim 11, wherein the coupling connection between the planar sun shield and the one of the first and second jaws is at a single point.

13. A method of shielding a passenger of a motor vehicle from sun glare, the method comprising:
providing a planar sun shield;
articulably mounting the sun shield to a structure within the vehicle with a device including a mounting member and a connecting member, the connecting member including at least one ball and socket joint; and
adjusting a position and/or orientation of the planar sun shield within the vehicle by articulating the at least one ball and socket joint.

14. The method of shielding a passenger of a motor vehicle from sun glare of claim 13, wherein the mounting member includes a pair of jaws and the articulably mounting the sun shield to a structure within the vehicle includes attaching the mounting member to a visor of the vehicle with the pair of jaws.

15. The method of shielding a passenger of a motor vehicle from sun glare of claim 13, wherein the at least one ball and socket joint includes first and second ball and socket joints.

16. The method of shielding a passenger of a motor vehicle from sun glare of claim 13, wherein the mounting member includes a suction cup and articulably mounting the sun shield to a structure within the vehicle includes attaching the mounting member to a glass surface of the vehicle selected from a windshield and a side window.
